(19) United States
(12) Patent Application Publication
(10) Pub. No.: US 2002/0059596 A1
(43) Pub. Date: May 16, 2002

(54) Device and method for distributing program information and terminal and device relating to the same

(76) Inventors: Kenji Sano, Yokohama (JP); Koji Kamogawa, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/835,296

(22) Filed: Apr. 12, 2001

(30) Foreign Application Priority Data
May 22, 2000 (JP) 2000-154362

(51) Int. Cl. G06F 3/00; H04N 5/445

(52) U.S. Cl. 725/39

(57) ABSTRACT

The present invention provides techniques that allow EPG(s) to be viewed and/or desired programs to be recorded remotely from the associated receiver, TV, and/or recording device. One embodiment provides a system that converts digital broadcast information, including program information, so that a handheld remote device, for example, a mobile telephone, or Personal Digital Assistant (PDA), can receive program information and further provides for the handheld remote device controlling a network connected recording device to record a broadcast program based on this program information.

### CROSS-REFERENCES TO RELATED APPLICATIONS

This application is related to and claims priority from Japanese Patent Application No. 200-154362, filed on May, 22, 2001.

### BACKGROUND OF THE INVENTION

The present invention relates generally to digital television (TV) broadcasts, and more particularly to techniques for the recording of digital broadcast programs scheduled from a handheld remote terminal.

Viewing program information for digital broadcasts requires viewing printed guide information or viewing an EPG (electronic program guide) on a TV screen.

Digital broadcasts generally have a very large number of broadcast programs with 200 channels or more. And EPG(s) provide greater efficiency since printing program guides can be expensive and using a printed guide to select and schedule programs to viewed or recorded is difficult.

EPG is a format defined by broadcast standards, and receivers and TVs receive and display EPG(s) sent according to this format. The user views the displayed EPG and views programs selected for viewing and records programs selected for recording.

However, in the case of receiving a broadcast directly from the digital broadcaster, viewing the EPG requires a receiver and TV for receiving and displaying the EPG. Thus, the user must be at the location of the TV to view the EPG.

Also, to view an EPG or a printed guide and select and record a desired program, a recording device is required in addition to the receiver and TV needed to make selections. Typically this requires the user to be at the location of the recorder to enter the desired program settings into the recorder. Even with a conventional remote control the user typically must be within line of sight of the recorder. Thus, a user in a remote location cannot control the recorder.

With the increasing use of communication networks, such as the Internet or public telephone network, devices, for example, home appliances, need not be controlled locally. If a device is remote controlled via a communications network user flexibility and use of time is improved by allowing a user to control his/her devices, for example, at home, while, for example, being on the road.

Therefore there is a need for techniques that allow EPG(s) to be viewed and to allow desired programs to be selected and recorded from remote locations.

### SUMMARY OF THE INVENTION

The present invention provides techniques that allow EPG(s) to be viewed and/or desired programs to be recorded remotely from the associated receiver, TV, and/or recording device. One embodiment provides a system that converts digital broadcast information, including program information, so that a handheld remote device, for example, a mobile telephone, or Personal Digital Assistant (PDA), can receive program information and further provides for the handheld remote device controlling a network connected recording device to record a broadcast program based on this program information.

In another embodiment of the present invention program information is extracted from broadcast information sent as a digital broadcast. The extracted program information data is converted into data that can be viewed by a standardized browser, for example HTML or XML. This converted data is received by a mobile terminal equipped with a standardized browser. The recording of programs is scheduled by a user using this mobile terminal, including the browser, and the data is sent to a remote video recorder via the Internet. The video recorder receives the program scheduling data and records the program(s) from the broadcaster.

An embodiment of the present invention provides a program information distributing device method. The method includes receiving broadcast information for a broadcast program, having Electronic Program Guide (EPG) information and program contents information from a broadcast station of a plurality of broadcast stations. The EPG information is extracted from the broadcast information and converted to a mark-up language format.

In another embodiment of the present invention a program information distributing device for receiving program information from a broadcaster of a plurality of broadcasters and distributing the program information to a plurality of mobile devices is provided. The program information distributing device includes: a broadcast information receiving unit for receiving broadcast information, comprising program information, from a broadcaster of said plurality of broadcasters; a program extracting unit for extracting said program information from said broadcast information; a data format converting unit for converting said program information to mark-up language information; and a data information transmitting unit for sending said mark-up language information to a mobile device of said plurality of mobile devices.

In yet another embodiment of the present invention a handheld device for controlling recording of a selected broadcast program of a plurality of broadcast programs by a video recording device via a communications network is provided. The handheld device includes: a receiving unit for receiving program guide information on said plurality of broadcast programs; a display for displaying to a user said program guide information; an input device for receiving a user selection of said selected broadcast program of said plurality of broadcast programs for recording; and an output device coupled with said communications network for sending to said video recording device control information to record said selected broadcast program.

In yet another embodiment of the present invention a recording device for recording a digital broadcast program from a broadcaster is provided. The recording device includes: a receiving unit for receiving digital broadcast information, including program information and said broadcast program, from said broadcaster; a network interface unit for receiving recording instructions to record said broadcast program from a cell phone or a PDA, said cell phone or said PDA coupled to said network interface via a communications network; and a video recording unit responsive to said recording instructions for recording said broadcast program.

In yet another embodiment, first, the EPG sent in a digital broadcast is converted into a format that can be received by a terminal such as a mobile phone. The terminal that receives this converted EPG is used to view the EPG and to specify programs selected for recording. This information is sent to a recording device. The recording device receives this information and performs selective recording.

These and other embodiments of the present invention are described in more detail in conjunction with the text below and attached figures.

### BRIEF DESCRIPTION OF THE DRAWINGS

FIG. 1 shows an architecture of a broadcast program recording system of an embodiment of the present invention.

FIG. 2 shows an architecture of a program information distributing device of an embodiment of the present invention.

FIG. 3 shows an architecture of a program information distributing device of another embodiment of the present invention.

FIG. 4 shows an architecture of a program information distributing device of another embodiment of the present invention.

FIG. 5 shows an architecture of a program information distributing device of yet another embodiment of the present invention

FIG. 6 shows an architecture of a communication terminal of an embodiment of the present invention

FIG. 7 shows a schematic view of a communication terminal of an embodiment of the present invention

FIG. 8 shows the main elements of an architecture of a communication terminal of another embodiment of the present invention.

FIG. 9 shows an architecture of a recording device of an embodiment of the present invention.

FIG. 10 shows an architecture of a recording device of another embodiment of the present invention.

FIG. 11 shows a schematic architecture of a broadcast program recording system of yet another embodiment of the present invention.

FIG. 12 shows a sample architecture of the recording device from FIG. 11.

FIG. 13 shows the main elements in another sample architecture of the recording device from FIG. 12.

### DESCRIPTION OF THE SPECIFIC EMBODIMENTS

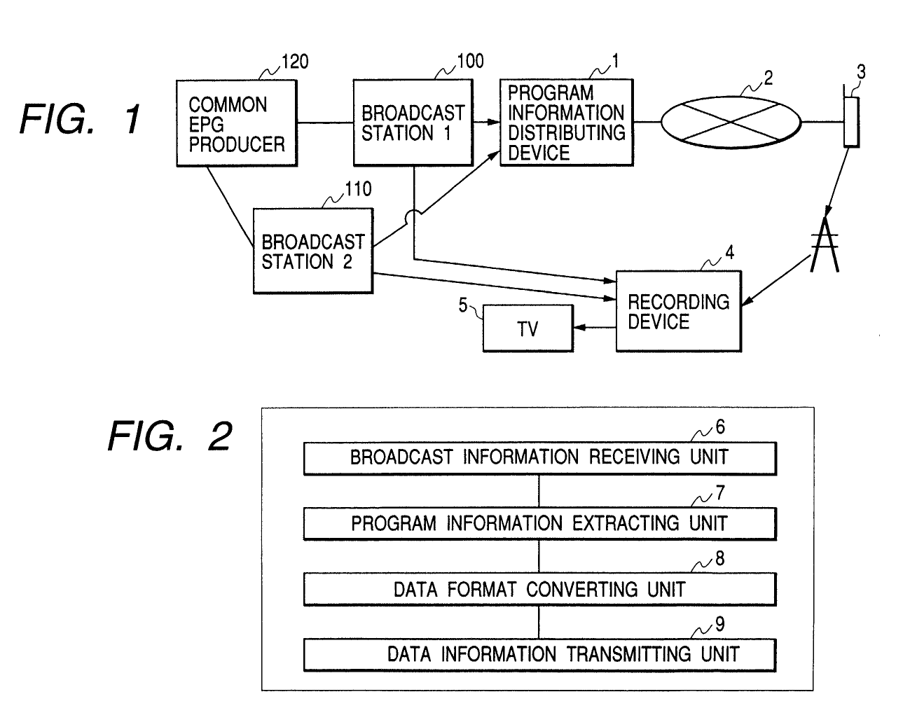

FIG. 1 is a schematic drawing of the architecture of a broadcast program recording system according to an embodiment of the present invention. This broadcast program recording system includes: a program information distributing device 1, a network 2 such as an internet, a communication terminal 3 (an information terminal such as a mobile phone or PDA), a recording device 4, and a TV 5.

FIG. 1 also shows an example of two broadcasting stations 100 and 110, which initially sends EPG information to Common EPG Producer 120, before sending broadcast information, including common EPG information and detailed EPG information, to program information distributing device 1. Broadcast station 100 sends, for example, a program title, program start time, and program duration time for a channel assigned to broadcast station 100 to Common EPG Producer 120. Broadcast station 110 also sends, for example, another program title, program start time, and program duration time for a channel assigned to broadcast station 110 to Common EPG Producer 120. Common EPG Producer 120 collects both channel program information and produces common EPG information, i.e., (TV) guide information, and sends the common EPG information back to both Broadcast Station 100 and Broadcast Station 110. The detailed EPG information sent by each broadcast station to the program information distributing device 1 in addition to the common EPG information, includes summary information of each program sent by a broadcaster. The detailed EPG information may include, for example, a synopsis of the program, the people involved, the type (e.g., action, horror) and a rating (e.g. PG-17, G).

Referring to FIG. 2, the program information distributing device 1 converts EPG data sent via a digital broadcast to a format that can be received by the communication terminals, for example, communication terminal 3. As shown in FIG. 2, the program information distributing device 1 includes: a broadcast information receiving unit 6 receiving digital broadcasts transmitted from a broadcast station 100 and a broadcast station 110; a program information extracting unit 7 for extracting program information, for example, EPG information, including common and detailed EPG information, from the received broadcast from, for example, broadcast station 100; a data format converting unit 8 converting the data format of the extracted program information to a data format, for example HTML or XML, that can be received by, for example, communication terminal 3, where the communication terminal could be, for example, a cellular phone or Personal Digital Assistant (PDA); and a data information transmitting unit 9 transmitting the converted data information to the communication terminals. Data information transmitting unit 9 does not need to transmit information continuously. Information can be transmitted when the communication terminal 3 accesses and connects to the program information distributing device 1 via network 2. If there is no continuous connection, the converted data is stored using a storage module such as memory. The data is then transmitted when it is accessed. In this case, a storing module can be added between data format converting unit 8 and data information transmitting unit 9 shown in FIG. 2. Also, data information transmitting unit 9 has communication features that allow it to receive incoming commands from the communication terminal 3. When there is an incoming read command, the data information stored in the storage module is read and this information is sent to data information transmitting unit 9 to be transmitted.

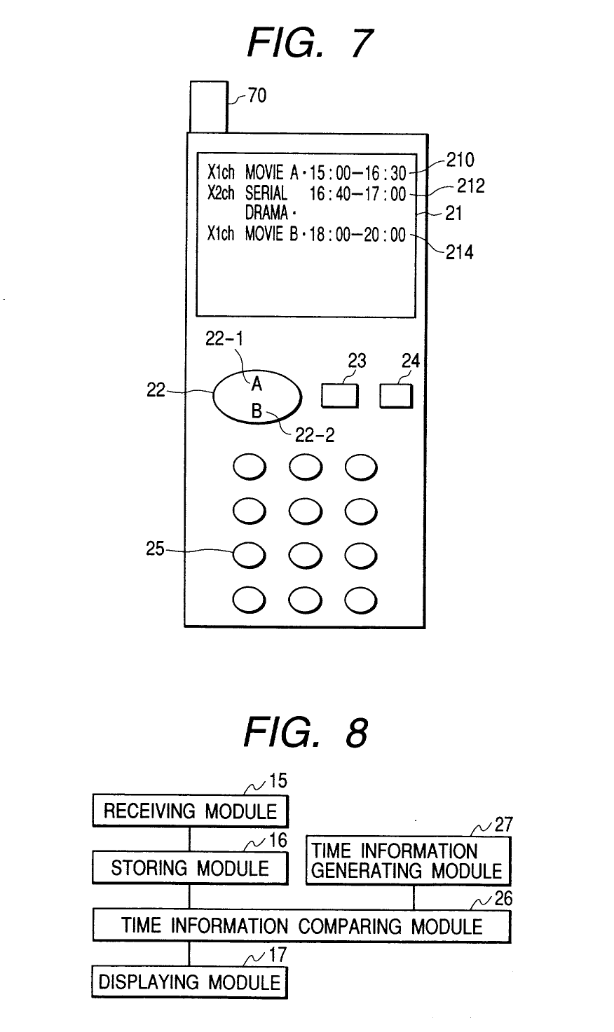

In an embodiment of the present invention, a plurality of broadcast stations, for example broadcast stations 100 and 110 in FIG. 1 have their broadcast received by the broadcast information receiving unit 6 (FIG. 2) of program information distributing device 1. Broadcast information from a broadcast station 100 includes program information common to both broadcast station 100 and 110 (i.e., common EPG information), such as a channel, a program title, a program start time, and a program duration time for each broadcast station, and detailed program (or EPG) information, which for broadcast station 100 includes, for example, a title, story synopsis, and type of a broadcast program of broadcast station 100. Broadcast station 110 also has the same common program information as broadcast station 100, but different detailed program. The program information extracting unit 7 extracts the common EPG information and the detailed EPG information from the broadcast information of broadcast stations 100 and 110. The data format converting unit 8 in one embodiment converts both the common EPG information and detailed EPG information to Hyper Text Markup Language (HTML) format, where the common EPG information has hyperlinks to the detailed EPG information. This HTML information is sent from the program information distributing device 1 over, for example, a cellular phone communications network 2 to communications terminal 3, such as a remote handheld device or mobile device, for example, a cell phone or PDA. The common EPG information in HTML format is displayed on a cellular phone display using for example a browser program (see FIG. 7 display 21, items 210, 212, and 214 for an example). If more information is desired by the user for item 210 (FIG. 7), for example, then item 210 is hyperlinked to detailed EPG information, which may include a synopsis of “movie A,” the actors, the type (e.g., action, horror) and a rating (e.g. PG-13, G). This detailed EPG information may itself contain hyperlinks to more information on the program. The hierarchical structure of common EPG information to detailed EPG information (level 1) to more detailed EPG information (level 2), etc., is necessary due to the limited screen area of the cell phone or PDA. Once a selection of a broadcast program to be recorded is made by the user, recording information or instructions is sent from, for example, a cell phone 3 to recording device 4, via, for example, the public telephone network or the Internet. The recording device 4 may have a modem that the remote device may connect to or the recording device 4 may be Web or Internet enabled and have a continuous connection to the Internet. In one embodiment the recording device 4 is connected via a cable modem to a server for its Internet connection and to a cable TV company system to receive the TV programs, both connections using the same cable. The recording device 4 receives the recording instructions from the remote handheld device 3 and records the selected broadcast programs from the broadcast stations 100 and 110. For example if on the display 21 (FIG. 7) item 210 :channel one (for example, Broadcast Station 100), movie A, from 15:00 to 16:30, is selected by the user for recording, then recording instructions are sent via an encrypted message by communication terminal 3 to recording device 4, to record movie A from broadcast station 100 at 15:00 to 16:30. The movie is then automatically recorded by recording device 4 at the specified time. Thus, a user can in effect record TV programs “at any time, anywhere.”

In an embodiment accesses and connections can be established by using connection methods used in standard internets. An embodiment in which an information transmitting unit 9 transmits information continuously primarily involves a plurality of communication terminals that function mainly to receive information. In this case, auxiliary information is added to the transmitted information, and the transmitted information can be received only by the communication terminals that can receive this auxiliary information. For example, communication terminals can be set up to be able to receive this auxiliary information. Once this auxiliary information is received, the transmitted information can be received. Thus, communication terminals that cannot receive this auxiliary information cannot receive the transmitted information. The communication terminal 3 is used to view the converted program information that was sent. Programs to be recorded are selected/specified with this terminal 3 and the information on programs to be recorded is sent to the recording device 4 via a network, for example, the Internet or public network, or the like. When a program sent from the broadcast station matches program information selected/specified for recording, the recording device records the program.

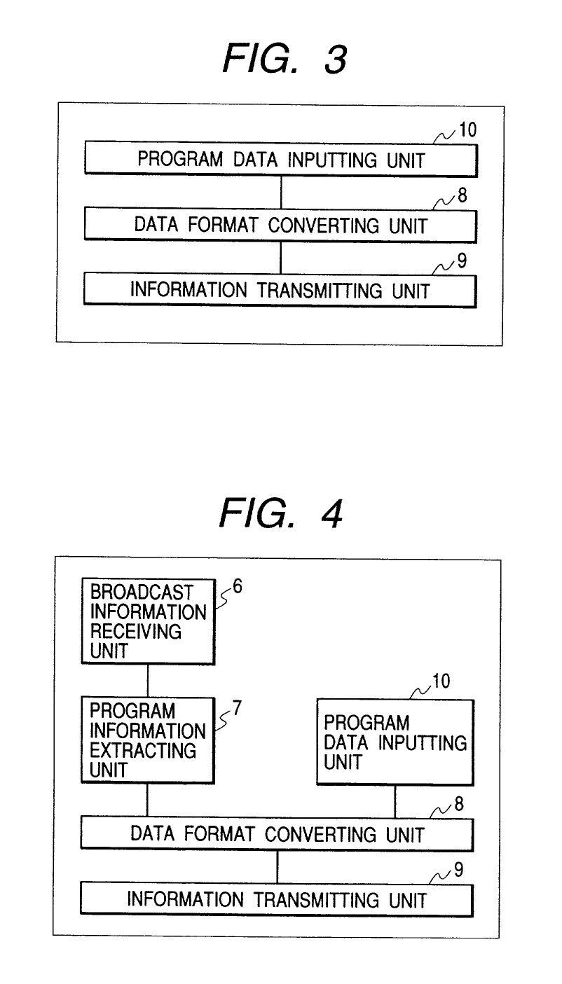

In the example above, a digital broadcast transmitted from the broadcast station is received and program information is extracted from the received broadcast. FIG. 3 shows an example where program data inputting unit 10 captures program information data from non-broadcast media. In this figure, program information receiving unit 6 is simply replaced with program data inputting unit 10. Program data inputting unit 10 is set up so that it can receive program data information from various media. For example, an input unit that can read the EPG of recorded programs from a recording medium (e.g., optical disks, semiconductor memory, or magnetic recording media) containing the EPG of broadcast programs can be used. Such an input unit can also be means for receiving information without using packaged media, e.g., wireless information.

Although not indicated in the diagram, data format converting unit 8 can be eliminated if the data format handled by an inputting unit is a data format that can be used by the communication terminal to receive EPG information of program broadcasts. Also, as shown in FIG. 4, the program information distributing device 1 can be formed with a program data inputting unit, a unit for extracting program information, and a unit for receiving broadcast programs. This allows digital broadcasts sent by the broadcast station to be received and allows program information to be extracted.

The following is a description of a sample method for converting data formats. For example, the program information distributing device 1 converts the data format into the HTML data format that can be seen on the Internet. The communication terminal can then be equipped with a browser that can read HTML formatted data. This eliminates the need for a dedicated receiving device for broadcast reception and allows EPG information to be handled in the same manner as standard Internet data. If the communication terminal is a cellular phone, the format can be a display data format used for cellular phones. This allows EPG information to be received even with cellular phones. In an alternative embodiment an eXtensible Markup Language (XML) data format may be used, either in place of or in addition to the HTML formatted data.

Broadcast information receiving unit 6 and program information extracting unit 7, and program data inputting unit 10 are means for capturing program information. Any means for capturing program information that uses media such as broadcast, communication, or other types of media can be used.

Program information extracting unit 7 can be set up so that it extracts program information that matches extracted information specified beforehand. In this case, since less information is extracted, the data format conversion time can be reduced. Also, the network can be used more efficiently since information transmitting unit 9 sends less information thus reducing the load on the network.

FIG. 5 shows a program information distributing device 1 of another embodiment of the present invention. Extraction information inputting unit 11 is used to indicate what is to be extracted from the program information. A storage module 12 stores the information extracted. A capturing module 14 compares the program information from a program information extracting module 13 and the program extraction information read from the storage module 12. And the program information matching the program extraction information is captured by the capturing module 14. The program information matching the program extraction information is output from the capturing module 14 to a data format converting unit 8. The subsequent operations are similar to those described above. As described above, extraction information inputting unit 11 can be packaged media or other means. The program extraction information used to extract program information can be information other than EPG information and content information about the programs themselves. For example, information about the viewer's interests (e.g., information about performers, movie genres) can be entered, and programs fitting these interests can be extracted.

Using the program information distributing device 1 described above, a service provider (hereinafter referred to as the distributor) situated between the broadcast station and the user can provide a program information distribution service. In this case, the distributor obtains program information from various media and provides this information to the user in return for which the user is billed in a predetermined manner.

In addition to program information, the distributor can also provide the user with other related information.

The billing procedure will be described. A web site relating to this service is provided for access by the user's terminal or PC. The web site includes a set-up screen for setting up user information used to perform billing. The user who wants to use this service enters the user information into this set-up screen and sends the information to the distributor's device. The distributor receives the entered user information and enters it into a database. Program information is then sent to the registered user. The user information can be information such as address, name, age, occupation, telephone number, e-mail address, credit card number, and bank account number. The distributor receives payment from the user through invoices, a bank account number, or a credit card.

Next, information relating to program information will be described. This service primarily involves the distribution of program information, but related information can also be sent to the user. This related information is provided by the program provider separate from the program information and can include promotional comments about a program, advertisements linked to programs that promote products, services, and the like, that appear in the programs, and shopping information linked to programs that allows the user to purchase products, services, and the like that appear in the programs. This additional information can be captured in the same manner that the program information is captured, as indicated in FIG. 2 through FIG. 4. In return for providing users with additional information, the distributor can charge, for example, the program provider providing the additional information.

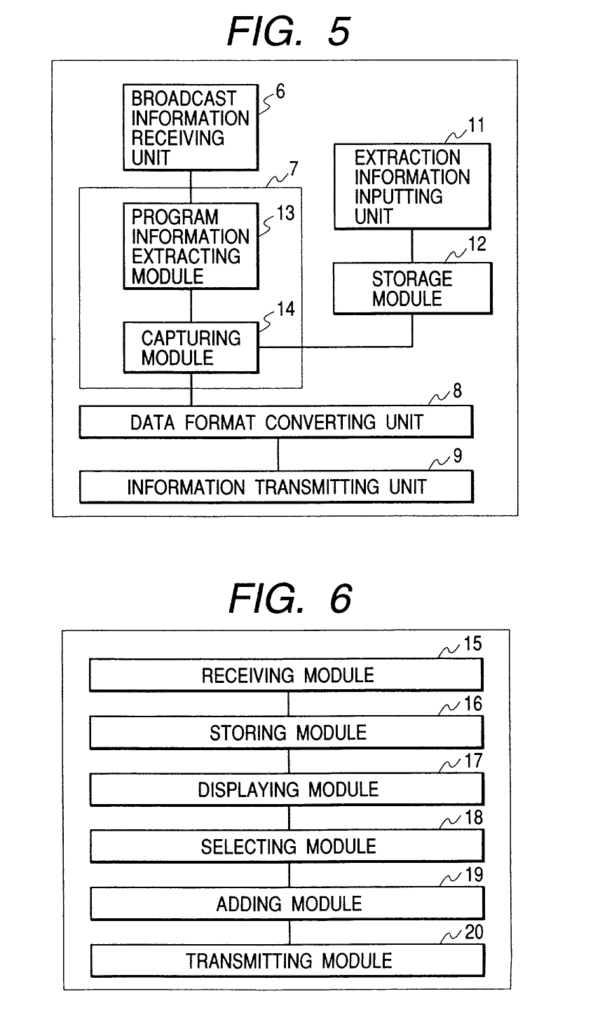

Next, an embodiment of an architecture of a communication terminal used in this system will be described, with references to FIG. 6.

The communication terminal includes: a receiving module 15 for receiving information transmitted by the program information distributing device 1; a storing module 16 for storing information received by receiving module 15; a displaying module 17 for displaying received information; a selecting module 18 for allowing programs to be selected from the displayed information; an adding module 19 for adding information to the selected program information so that a recording device can perform recording operations; and a transmitting module 20 for transmitting the output signal from the adding module 19. Adding module 19 adds signals that can be recognized by the recording device as indicating the beginning and end of transmitted information. Storing module 16 is provided so that information stored in the storing module can be used even if there is not a continuous connection to an internet network or the like. Once program information is received through this communication network, the connection to the network can be terminated, thus allowing the communication network to be used efficiently. While a continuous connection can be used, this prevents the efficient use of the network, as described above. The procedure for receiving program information and sending information about programs to be recorded to the recording device follows the sequence of modules shown in FIG. 6 from top to bottom. While not shown in FIG. 6, selection results from selecting module 18 are stored sequentially in a recording medium. After the selection operation is completed, the selection results are read from the recording medium and output. In this case, the recording medium can be the same storage medium used by storing module 16.

FIG. 7 shows a schematic view of a sample communication terminal 3 of an embodiment of the present invention. A communication module 70 receives information transmitted by the program information distributing device 1 and transmits signals from the communication terminal 3. A display screen 21 displays program information, for example, common EPG information 210, 212, and 214. An operation module 22 is used to select programs to be recorded from the program information displayed on the display module. If multiple programs are displayed, the program indicated by entries from the operation module is displayed in a manner that allows it to be distinguished from the other programs. The display method can involve displaying the indicated program using reverse text relative to the other programs, displaying the program using a different color from that of the other programs, highlighting, or displaying a tag. The operation module 22 is a levered or pressure-sensitive key. Pressing the A section 22-1 moves the highlighted section upward in the figure and pressing the B section 22-2 moves it downward in the figure. A selection execution operation module 23 can be, for example, a key. By pressing this key, the selection of a program to be recorded is entered and stored in the storage module. An execution canceling operation module 24 is optional. If it is not provided, selections can be cancelled through other methods such as by using the selection execution operation module 23 to perform the selection execution operation twice in a row. This can be done by having the software recognize one operation as execution and two consecutive operations as cancellation. In the canceling operation, a read operation is performed to read the information stored in memory and confirmation is requested through the display module. The operation button 22 is used in the same manner as described above to specify the program on the display module to be cancelled. The canceling operation is performed and the selection is cancelled. When this is done, the information is cleared from memory as well. An operation module 25 is used to send the selected program information to the recording device. If the communication terminal is a mobile phone, data is transmitted through a telephone network. The received EPG is first read from memory. Results from the program selection operation are stored in the storage module. In the transmitting operation, these results are read from the storage module and transmitted. The transmission may be through the public telephone network to the recording device or from the telephone network to the Internet to the recording device.

A clock feature can be provided in the communication terminal 3. This allows it to determine whether a program selected for recording can be recorded by comparing the current time with time information about the selected program such as starting time. This time information can also be used so that only information about programs that can be recorded is displayed on the display module. By doing this, the need to display information about programs that cannot be recorded is eliminated, and the need to refer to the EPG for programs that cannot be recorded is eliminated, thus making the operation for selecting programs to be recorded easier. FIG. 8 relates to the time information described above. A time information comparing module 26 is placed between storing module 16 and displaying module 17 from FIG. 6. Time information comparing module 26 compares the time information of the program information read from storing module 16 with the current time from time information generating module 27 (the current time as of when the program selection operation is performed on the communication terminal). If the comparison of time information indicates that the program broadcast time is already over at the current time, the corresponding program information is not displayed. Information about programs having broadcast times that allow recording is sent to displaying module 17. If a program is being broadcast while the program recording selection operation is taking place, the corresponding program information is output to displaying module 17. In this case, the display module indicates that the program is in progress. For example, the information about the program in progress can be displayed on display screen 21 with blinking text, a character or mark placed next to the program information can be displayed to indicate the program is in progress, or a different display color from the color for programs not in progress can be used. The EPG information for all selected programs can be transmitted, but it would also be possible to store only the channel number and broadcast times when selecting the programs to be recorded and to send only this information.

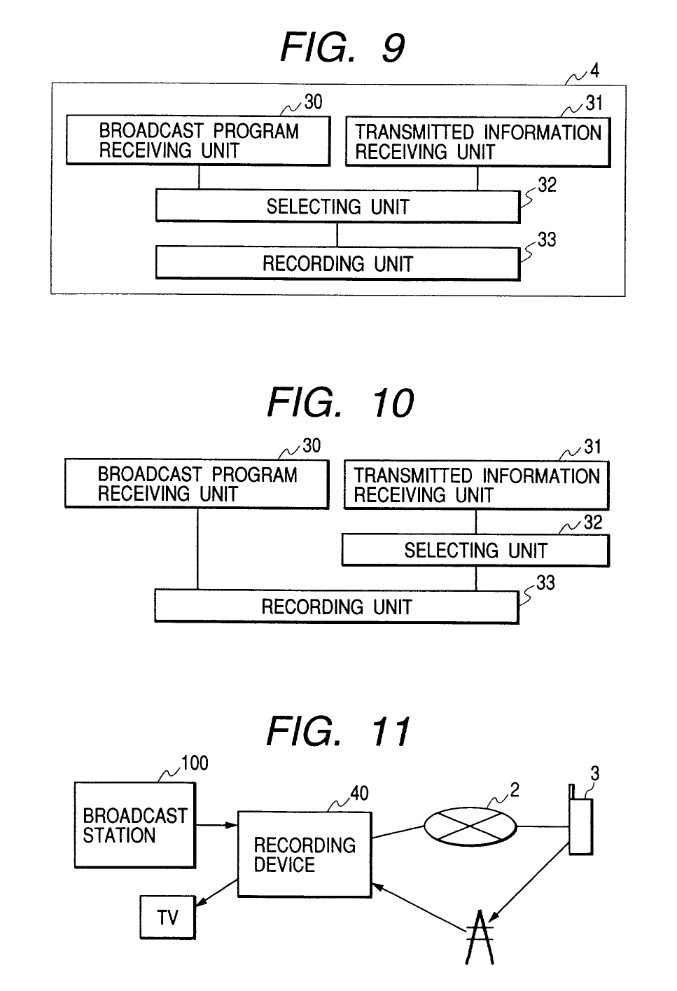

Next, the schematic architecture of an embodiment of a recording device will be described with references to FIG. 9. A broadcast program receiving unit 30 receives broadcast programs. A transmitted information receiving unit 31 receives information transmitted from the communication terminal 3. A selecting unit 32 receives from the transmitted information receiving unit 31, the EPG information to be recorded and converts it to the same format as the EPG of the transmitted broadcast. Then, programs matching the converted EPG format are selected and information to be recorded is sent to the recording unit 33, for example, a Video Cassette Recorder (VCR) or Digital Video Disk (DVD) recorder or CD recorder or Hard Disk Drive (HDD). Transmitted information receiving unit 31 can be set up so that when information about a program to be recorded is received, confirmation information can be sent to the communication terminal 3 to indicate that the information has been correctly sent to the recording device. The communication terminal is set up to receive and display this confirmation information. This allows the user to confirm at any time that a recording operation is scheduled, thus preventing the user who forgot that a recording is scheduled from making a redundant scheduling. Recording unit 33 records to a recording medium installed in the recording device or to a recording medium mounted in the recording device. Selecting unit 32 also sends recording unit 33 information added to the EPG of the program to be recorded. This added information is used to perform recording operations of the specified program. The recording operation information is recorded only when a program selected by selecting unit 32 is sent and recording is stopped when nothing is sent from selecting unit.

In another embodiment the recording device can also be formed with the architecture shown in FIG. 10. The figure shows a broadcast program receiving unit 30, a transmitted information receiving unit 31, and a selecting unit 32. Selecting unit 32 extracts information such as the channel and the starting and ending times from the EPG received by transmitted information receiving unit 31 for programs to be recorded. This information is sent to recording unit 33 as a signal used for timed recording. Alternatively, if only the channel and broadcast time information to be recorded is received by transmitted information receiving unit 31, as described above, selecting unit 32 converts this information into information that can operate the timer of recording unit 33 and sends this to recording unit 33. Timed recording operations on recording unit 33 are performed the same as in conventional technology. Broadcast program receiving unit 30 uses the time information of the recording device so that it is activated slightly before (or at the same time) as the recording start time and stops receiving operations when the recording stop time is reached and recording is stopped. For example, the recording start time information can be stored, and this recording time information is compared with the time information from the time feature of the recording device 33. When the time information is one minute before the recording start time, receiving unit 30 is activated. This eliminates the need to keep receiving unit 30 active continuously, and power is consumed by the receiving means module of the recording device only when recording. The recorded program is viewed on a TV using the standard playback operation of the recording device.

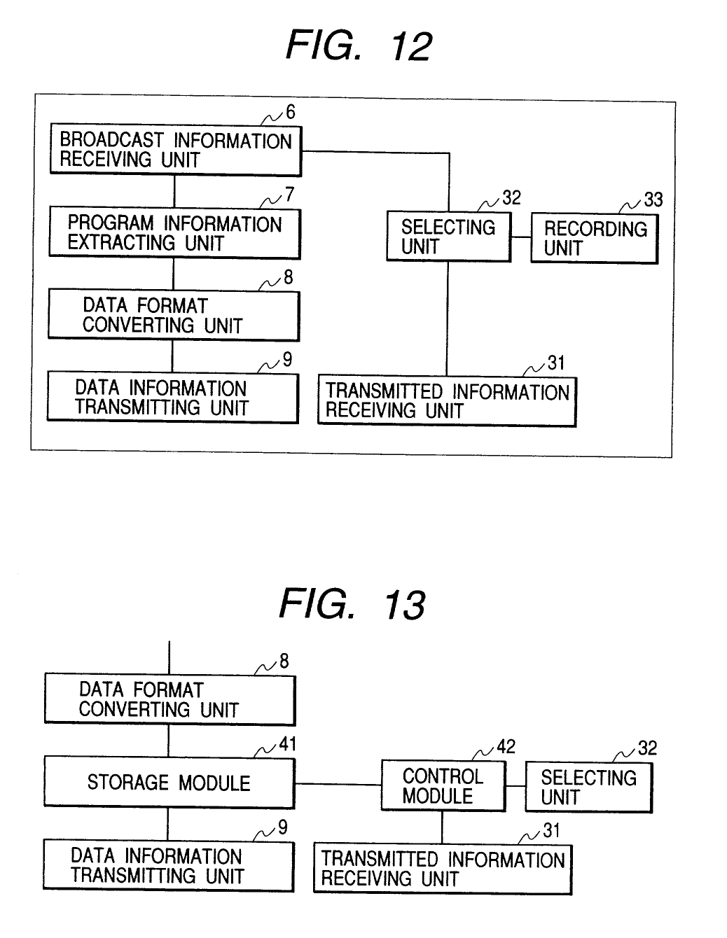

FIG. 11 shows the schematic architecture of a system that uses a device that integrates a program distributing device and a recording device (the figure indicates a recording device) of an embodiment of the present invention. FIG. 12 shows the schematic architecture of a recording device of an embodiment of the present invention.

FIG. 11 shows a recording device 40 that integrates a program information distributing device and a recording device, the network 2, such as the Internet, and the communication terminal 3. The recording device 40 receives broadcasts from the broadcast station 100, extracts program information (EPG), converts the program information to a data format that can be received by the communication terminal 3, and sends this converted data. The recording device 40 then receives the program recording information from the communication terminal 3 and records programs based on this received information from broadcast station 100.

FIG. 12 is a schematic architecture drawing of the recording device 40 of another embodiment of the present invention. The figure shows broadcast information receiving unit 6, program information extracting unit 7, data format converting unit 8, data information transmitting unit 9, transmitted information receiving unit 31, selecting unit 32, and recording unit 33. EPG is sent to the communication terminal 3 as described above. The operations for receiving recording information from the communication terminal 3 and recording to recording unit 33 are also as described above.

FIG. 13 shows yet another embodiment of the recording device from FIG. 12. When there is a request from the communication terminal 3, EPG information is sent to the communication terminal 3. The programs to be recorded are set up using the communication terminal 3 and the settings information is sent to the recording device 40. The information is then used to record to the recording device 40. In this example, a storage module 41 used to store EPG information is placed between data format converting unit 8 and data information transmitting unit 9. A control module 42 uses the signal received by transmitted information receiving unit 31 to determine if it is an EPG transmission or a recording transmission. If it is a recording transmission, the transmitted data sent from the communication terminal 3 is sent to selecting unit 32. EPG transmission to the recording device can be sent using other inputting units, as described above.

In one embodiment of the present invention, a program information distributing device converts the EPG format and transmits the converted information so that even without a digital broadcast receiving device, the EPG from a digital broadcast can be easily received by a communication terminal such as a mobile phone or PDA, thus allowing broadcast programs to be easily known by a user. The communication terminal can then be used from nearly anywhere at nearly any time to select a program to be viewed and to schedule a recording device.

Although the above functionality has generally been described in terms of specific hardware and software, it would be recognized that the invention has a much broader range of applicability. For example, the software functionality can be further combined or even separated. Similarly, the hardware functionality can be further combined, or even separated. The software functionality can be implemented in terms of hardware or a combination of hardware and software. Similarly, the hardware functionality can be implemented in software or a combination of hardware and software. Any number of different combinations can occur depending upon the application.

The preceding has been a description of the preferred embodiments of the invention. It will be appreciated that deviations and modifications can be made without departing from the scope of the invention, which is defined by the appended claims.

What is claimed is:

1. A program information distributing method comprising:
receiving digital broadcast information for a broadcast program, comprising Electronic Program Guide (EPG) information and program contents information from a broadcast station of a plurality of broadcast stations;
extracting from said digital broadcast information, EPG information; and
converting said EPG information to a mark-up language format.

2. The program information distributing method of claim 1 further comprising:
transmitting said EPG information in said mark-up language format to a remote handheld user device.

3. The program information distributing method of claim 2 wherein said remote handheld user device is selected from a group consisting of a mobile telephone or a Personal Digital Assistant (PDA).

4. The program information distributing method of claim 1 wherein said EPG information comprises, common EPG information and detailed EPG information, said common EPG information comprising guide information for channels of said plurality of broadcast stations, and said detailed EPG information comprising program information specific to said broadcast program.

5. The program information distributing method of claim 4 wherein said guide information comprises a channel, a program title, a program start time, and a program duration time.

6. The program information distributing method of claim 4 wherein said detailed EPG information comprises a program synopsis.

7. A method for remotely controlling a video recorder using a remote handheld device, said video recorder for recording a broadcast program, said method comprising:
said remote handheld device receiving program information on said broadcast program from a program information source;
selecting said broadcast program for recording from said program information displayed by said handheld remote device; and
said remote handheld device transmitting recording information to said video recorder via a communications network, said recording information for recording of said broadcast program by said video recorder.

8. The method of claim 7 wherein said communications network comprises an internet.

9. The method of claim 7 wherein said communications network comprises a public telephone network.

10. The method of claim 7 wherein said remote handheld device is used out of a line of sight of said video recorder.

11. The method of claim 7 wherein said remote handheld device is a cellular phone.

12. The method of claim 7 wherein said remote handheld device is a Personal Digital Assistant (PDA).

13. The method of claim 7 wherein said program information source is a program information distributing device.

14. The method of claim 13 wherein said broadcast program and said program information are sent from a broadcaster to said program information distributing device on one channel.

15. The method of claim 7 wherein said video recorder is a VCR.

16. The method of claim 7 wherein said video recorder is a DVD recorder.

17. The method of claim 7 wherein said video recorder is a Hard Disk Drive (HDD).

18. The method of claim 7 wherein said program information is conditionally displayed by said handheld remote device depending on a current time and time information associated with said broadcast program.

19. A program information distributing device for receiving program information from a broadcaster of a plurality of broadcasters and for distributing said program information to a plurality of mobile devices, said program information distributing device comprising:
a broadcast information receiving unit for receiving broadcast information, comprising program information, from a broadcaster of said plurality of broadcasters;
a program extracting unit for extracting said program information from said broadcast information;
a data format converting unit for converting said program information to mark-up language information; and
a data information transmitting unit for sending said mark-up language information to a mobile device of said plurality of mobile devices.

20. The program information distributing device of claim 19 wherein said mobile device includes a browser program to display said mark-up language information to a mobile device user.

21. The program information distributing device of claim 19 wherein said mobile device includes a cell phone.

22. The program information distributing device of claim 19 wherein said mobile device includes a PDA.

23. The program information distributing device of claim 19 wherein said mark-up language information, comprises HTML information.

24. The program information distributing device of claim 19 wherein said mark-up language information, comprises XML information.

25. A handheld device for controlling recording of a selected broadcast program of a plurality of broadcast programs by a video recording device via a communications network, said handheld device comprising:
a receiving unit for receiving program guide information on said plurality of broadcast programs;
a display for displaying to a user said program guide information;
an input device for receiving a user selection of said selected broadcast program of said plurality of broadcast programs for recording; and
an output device coupled with said communications network for sending to said video recording device control information to record said selected broadcast program.

26. The handheld device of claim 25 wherein said program guide information comprises common Electronic Programming Guide (EPG) information, said common EPG information sent by all broadcasters of said plurality of broadcast programs.

27. The handheld device of claim 26 wherein said common EPG information comprises a channel, a program title, a program start time, and a program duration time for each broadcast program of said plurality of broadcast programs.

28. The handheld device of claim 25 wherein said program guide information further comprises detailed EPG information, said detailed EPG information sent by a broadcaster of a broadcast program of said plurality of broadcast programs, and said detailed EPG information comprising a title, story synopsis, and type for said broadcast program.

29. A handheld device for controlling recording of a digital broadcast program by a video recording device via a communications network, said handheld device comprising:
a processor coupled to a memory for executing a browser program stored in said memory;
a receiving unit for receiving program information on said digital broadcast program;
a display for displaying to a user said program information using said browser program;
an input device for receiving a user selection of a selected digital broadcast program for recording; and
when said user selection, comprises said program information, commanding said video recording device to record said digital broadcast program.

30. The handheld device of claim 29 wherein said program information, comprises common EPG information and detailed EPG information, for said digital broadcast program.

31. The handheld device of claim 30 wherein said common EPG information is displayed on said display, and responsive to a user input for more program information on said digital broadcast program, said detailed EPG information is displayed.

32. The handheld device of claim 30 wherein said detailed EPG information for said digital broadcast program comprises a title, story synopsis, and type.

33. The handheld device of claim 29 wherein said program information, comprises common EPG information.

34. The handheld device of claim 33 wherein said common EPG information comprises a title and a time.

35. The handheld device of claim 29 wherein said browser program is HTML or XML enabled.

36. The handheld device of claim 29 wherein said displaying to a user said program information, comprising a start time, is performed only if said start time is on or after said current time.

37. The handheld device of claim 29 further comprising a time information comparing module for comparing said program information, comprising a start time, with a current time and wherein said program information is displayed on said display only if said digital broadcast program can be recorded.

38. The handheld device of claim 29 wherein said receiving unit further receives confirmation information from said video recording device on said commanding.

39. A recording device for recording a digital broadcast program from a broadcaster comprising:
a receiving unit for receiving digital broadcast information, including program information and said broadcast program, from said broadcaster;
a network interface unit for receiving recording instructions to record said broadcast program from a cell phone or a PDA, said cell phone or said PDA coupled to said network interface via a communications network; and
a video recording unit responsive to said recording instructions for recording said broadcast program.

40. The recording device of claim 39 wherein said network interface unit has a continuous Internet connection to said communications network.

41. The recording device of claim 39 wherein said communications network, comprises a public telephone system.

42. The recording device of claim 39 wherein said cell phone or PDA initiates said recording instructions by calling said network interface unit.
